(19) United States
(12) Patent Application Publication
(10) Pub. No.: US 2022/0045543 A1
(43) Pub. Date: Feb. 10, 2022

(54) ISOLATED MULTI-PORT RECHARGE SYSTEM

(71) Applicant: ENURE, INC., Los Angeles, CA (US)

(72) Inventors: Eric E. Rippel, Los Angeles, CA (US); Wally E. Rippel, Altadena, CA (US)

(21) Appl. No.: 17/507,608

(22) Filed: Oct. 21, 2021

Related U.S. Application Data
(63) Continuation of application No. 16/783,042, filed on Feb. 5, 2020, now abandoned.
(60) Provisional application No. 62/802,168, filed on Feb. 6, 2019.

(51) Int. Cl. H02J 7/04; H02J 7/00; H02J 50/40; H02J 50/10

(52) U.S. Cl. CPC H02J 7/04; H02J 7/0013; H02J 2207/20; H02J 50/10; H02J 50/40

(57) ABSTRACT

A multi-port recharge system. In some embodiments, the multi-port recharge system includes a transformer having one or more secondary windings, each of which connects to a non-isolated AC to DC converter. The primary of the transformer may connect to medium voltage utility power.

### CROSS-REFERENCE TO RELATED APPLICATION(S)

The present application is a continuation of U.S. patent application Ser. No. 16/783,042, filed Feb. 5, 2020, entitled “ISOLATED MULTI-PORT RECHARGE SYSTEM”, which claims priority to and the benefit of U.S. Provisional Application No. 62/802,168, filed Feb. 6, 2019, entitled “ISOLATED MULTI-PORT RECHARGE SYSTEM”, the entire contents of all of the documents identified in this paragraph are incorporated herein by reference.

### BACKGROUND

At present, maximum electric vehicle recharge rates are around 350 kW. Accordingly, for public recharge stations, where four or more ports are included, total demand can be in excess of 1 MW. As battery development continues, it is likely that power levels will go even higher. In order to support such power levels, medium voltage utility interface (three-phase voltage levels in excess of 1 kV) is desired in combination with a dedicated utility grade step-down transformer. With this design decision in place, it follows that the above utility transformer can be modified to provide individually isolated secondaries for each respective recharge port—with little added expense per unit power rating. No second transformer is required—thus reducing cost, size, and power loss.

### BRIEF DESCRIPTION OF THE FIGURES

FIG. 1 is a block diagram of a first embodiment of the isolated, multi-port recharge system, where neither harmonic compensation nor energy storage is included.

FIG. 2 is a block diagram of a second embodiment of the isolated, multi-port recharge system, where harmonic compensation is included.

FIG. 3 is a block diagram of a third embodiment of the isolated, multi-port recharge system, where both harmonic compensation and energy storage are included.

FIG. 4 is a block diagram of a first embodiment of the isolated, multi-port recharge system, where neither harmonic compensation nor energy storage is included, and where non-isolated AC to DC converters are used for each recharge port.

FIG. 5 is a block diagram of a second embodiment of the isolated, multi-port recharge system, where harmonic compensation is included, and where non-isolated AC to DC converters are used for each recharge port.

FIG. 6 is a block diagram of a third embodiment of the isolated, multi-port recharge system, where both harmonic compensation and energy storage are included, and where non-isolated AC to DC converters are used for each recharge port.

### DETAILED DESCRIPTION OF THE FIGURES

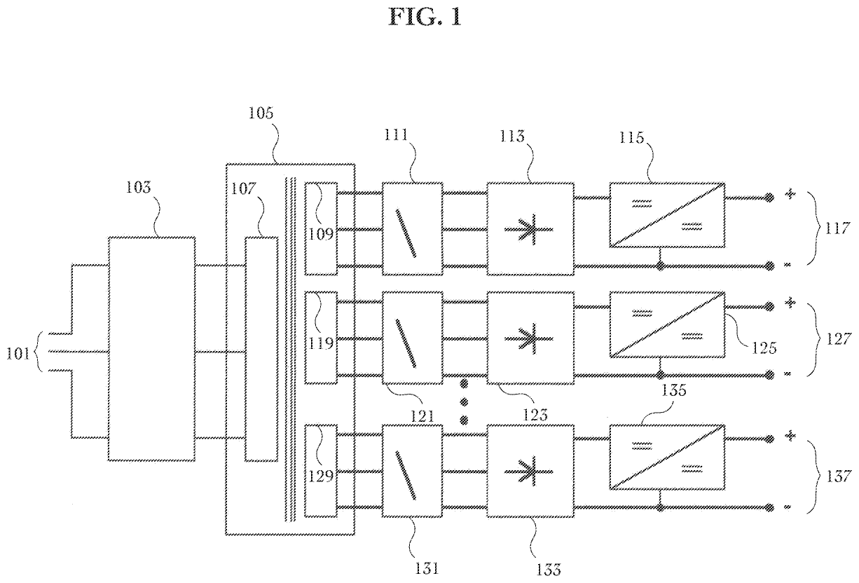

In FIG. 1, medium voltage utility power is applied via medium voltage utility feeder 101 to utility disconnect and protection 103, which in turn transmits power to primary 107 of utility transformer 105. Power received at secondary 109 is then sent via protection and disconnect 111 to three-phase rectifier 113. The DC output of rectifier 113 is then applied to the input of buck regulator 115 which reduces the voltage to the desired level for application to recharge port 117. Elements 119 through 127 provide a second, similar isolated recharge port. Replication continues for a total of N isolated recharge ports. The individual recharge ports may have identical voltage and power ratings or may have differing voltage and/or power ratings.

Utility disconnect and protection 103 may consist of fuses, a circuit breaker, or both. It may also include a disconnect switch.

The transformer primary winding may be either a delta or wye configuration. Likewise, each secondary winding may be either a delta or wye configuration. By mixing secondary configurations, such that approximately half the secondary power is handled by delta windings and half by wye windings, primary-side current harmonic distortion can be minimized. In the ideal case, primary side current harmonic distortion (THD) can be as low as 15%.

Secondary disconnect and protection 111 through 131, may each consist of fuses, a circuit breaker, or both. They may also include disconnect switches.

Three-phase rectifiers 113 through 133 may each consist of six rectifier diodes connected as a three-phase bridge.

Buck regulators 115 through 135 may each be single or poly-phase. With poly-phase versions, input and output capacitors can be reduced in size and expense. Each regulator may be controlled in current-mode; voltage constraints may be applied.

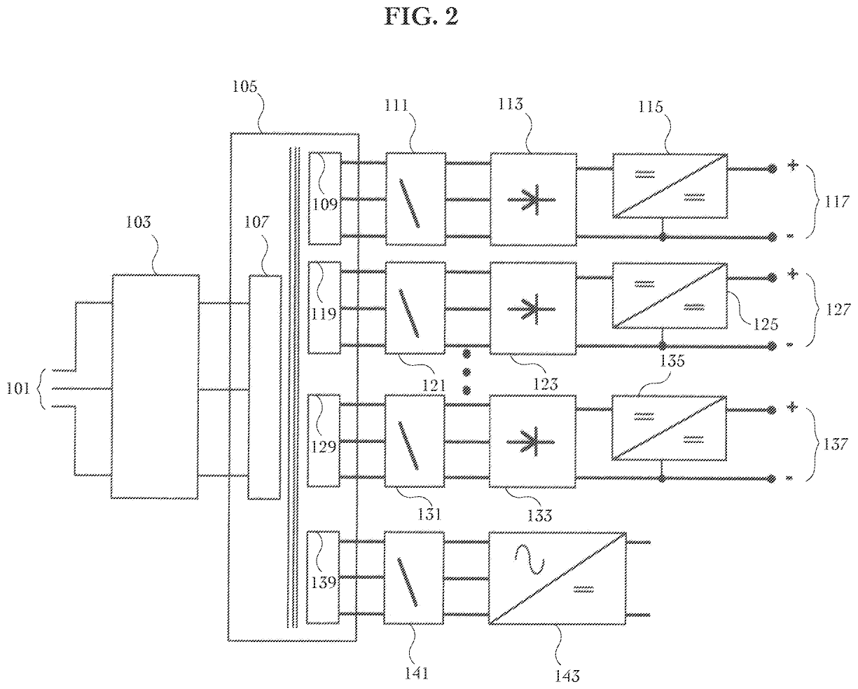

With the system shown in FIG. 2, harmonic compensation is added such that primary harmonics can be reduced to arbitrarily low values. Line-tie inverter 143 connects to transformer secondary 139 via disconnect and protection 141. Control of inverter 143 is such that zero real power is maintained while producing phase currents which cancel harmonic currents produced by rectifiers 113 through 133. In addition, the inverter may be controlled such that positive or negative VARs are supplied to the utility. Typically, inverter 143 consists of three switching poles which connect through inductance to the phase port. Capacitance is applied across the DC port. In the case where delta and wye secondary loads are balanced, an inverter kVA rating equal to 16% of the total recharge kW may be sufficient to provide full harmonic compensation.

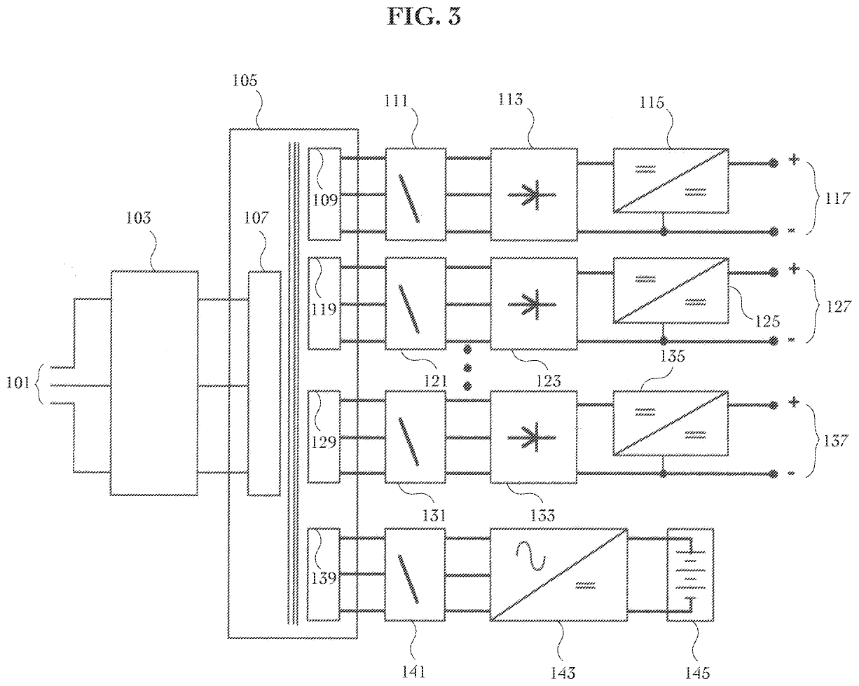

With the system shown in FIG. 3, energy storage is added such that energy can be exchanged between battery 145 and the utility, and/or between battery 145 and recharge ports 117 through 137; real power flow is under control of inverter 143. Energy storage battery 145 is galvanically isolated via secondary winding 139.

In addition, inverter 143 of FIG. 3 can also be used to provide harmonic compensation as with the FIG. 2 system. The total kVA supplied by the inverter is equal to the square root of the sum of the squares of the real power and the harmonic kVA. Thus, in the case where the battery recharge/discharge power is large compared with the harmonic kVA, the inverter VA requirement is essentially equal to the battery power, and harmonic compensation is provided at virtually no cost in terms of power components.

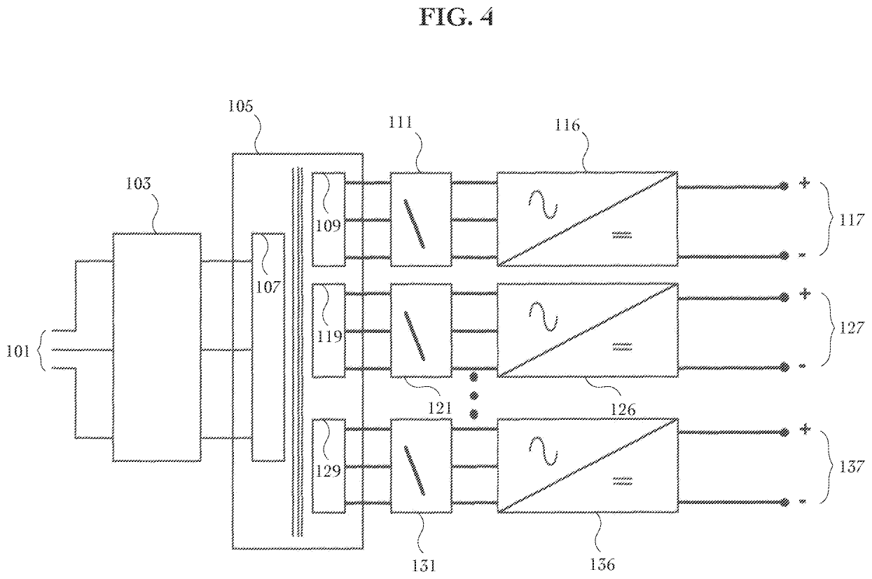

The system shown in FIG. 4 is similar to that of FIG. 1, except that rectifiers 113 through 133 and switching regulators 115 through 135 have been replaced respectively by non-isolated AC to DC converters 116 through 136. Each such AC to DC converter may consist of an inverter, or a combination of an inverter and a switching regulator.

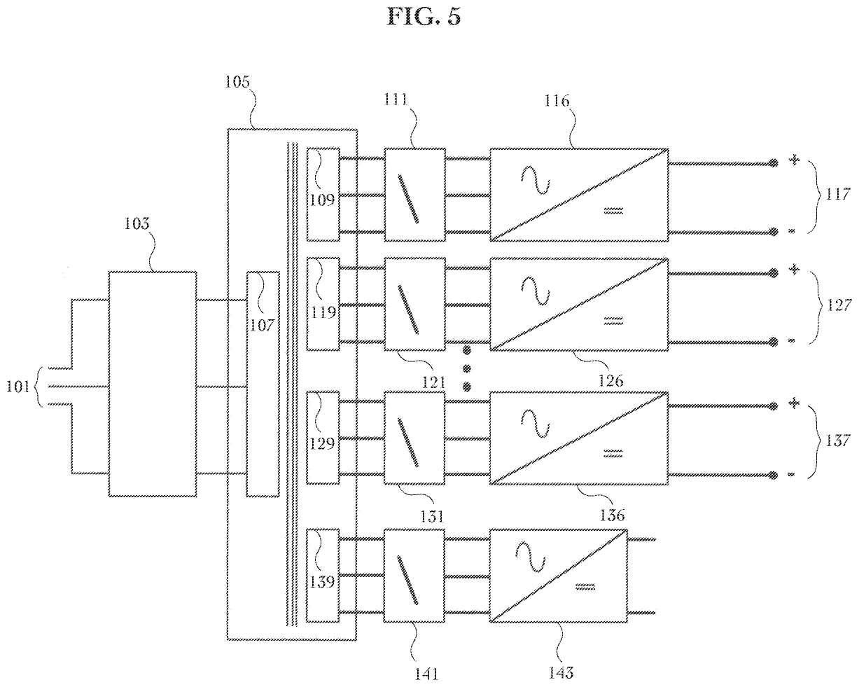

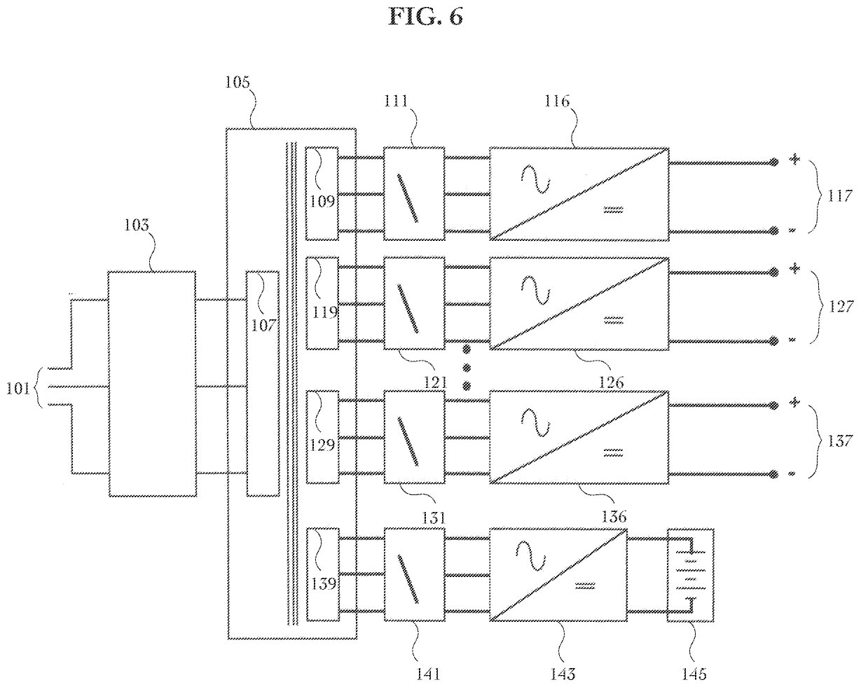

The system shown in FIG. 5 is similar to that of FIG. 3, except that rectifiers 113 through 133 and switching regulators 115 through 135 have been replaced respectively by non-isolated AC to DC converters 116 through 136. Each such AC to DC converter may consist of an inverter, or a combination of an inverter and a switching regulator. The system shown in FIG. 6 is similar to that of FIG. 3, except that rectifiers 113 through 133 and switching regulators 115 through 135 have been replaced respectively by non-isolated AC to DC converters 116 through 136. Each such AC to DC converter may consist of an inverter, or a combination of an inverter and a switching regulator.

1. A multi-port, isolated battery recharge system which comprises a transformer having one or more secondary windings, each of which connects to a non isolated AC to DC converter, wherein the primary of the transformer connects to medium voltage utility power.
